(19) United States
(12) Patent Application Publication
(10) Pub. No.: US 2022/0415020 A1
(43) Pub. Date: Dec. 29, 2022

(54) SYSTEM AND METHOD FOR DETECTION OF ANOMALIES IN WELDED STRUCTURES

(71) Applicant: NEWFREY LLC, New Britain, CT (US)

(72) Inventors: Amir R. KASHANIPOUR, Washington, DC (US); Sayyed M. ZAHIRI, Atlanta, GA (US); Gabriel J. ELPERS, Houston, TX (US)

(21) Appl. No.: 17/929,041

(22) Filed: Sep. 1, 2022

Related U.S. Application Data
(63) Continuation of application No. PCT/US2021/020840, filed on Mar. 4, 2021.
(60) Provisional application No. 62/985,476, filed on Mar. 5, 2020.

(51) Int. Cl. G06V 10/764; G06T 7/00; G06T 7/73; G06T 7/68; G06V 10/82; G06T 7/11; B23K 31/12

(52) U.S. Cl. CPC G06V 10/764; G06T 7/001; G06T 7/74; G06T 7/68; G06V 10/82; G06T 7/11; B23K 31/125; G06T 2207/30152; G06T 2200/24; G06T 2207/10116; B23K 2101/10

(57) ABSTRACT

A non-destructive system for detecting anomalies in weldment of a pipeline is provided including an imaging apparatus, an anomaly detection unit, and a computing device. The imaging apparatus produces image segments corresponding to segments of the circumferential area of the weldment. The anomaly detection unit includes an artificial intelligence platform that processes and analyzes the image segments to identify at least one of a type, size, and location of a welding anomaly within the weldment using a database of truth data. The computing device includes a graphical user interface that displays the image segments with an overlay of information relating to at least one of the type, size, and location of the welding anomaly to the user.

### RELATED APPLICATION

This application is a continuation of PCT Application No. PCT/US2021/020840, filed Mar. 4, 2021, which claims the benefit of U.S. Provisional Application No. 62/985,476 filed Mar. 5, 2020 and titled “SYSTEM AND METHOD FOR DETECTION OF DEFECTS IN WELDED STRUCTURES,” content of which is incorporated herein by reference in its entirety.

### FIELD

This disclosure relates to detection classification and risk assessment of surface and sub-surface discontinuities, anomalies and defects in weldment and heat affected zones, and in particularly to use of an artificial intelligence system or platform for automatic detection of anomalies in a pipeline weldment.

### BACKGROUND

Identifying discontinuities, anomalies, and defects in a weldment, particularly in oil and gas pipelines where a defect in welding of pipelines can lead to a leak at a high cost economically and environmentally, or any other girth weldment, is of immense importance. Discontinuities, anomalies and defects may occur in weld nugget portion of the weldment, or in thermo-mechanically affected zone (TMAZ) or heat-affected zone (HAZ) portions of the pipelines or surfaces to be welded. Various types of anomalies may include, but are not limited to, cracks, presence of pores and bubbles, incomplete or insufficient penetration of weldment, linear misalignment of metallic bodies, lack of thorough fusion between the metallic bodies, undercut or overenforcement of weld material in upper or lower weld zones, or blowout of the top surface formation. While some anomalies may be determined to be defects that can lead to breakage and leakage, so may be considered acceptable by an inspector. Early identification of presence, type, size, and location of anomalies in weldments can help welding and inspection technicians make the necessary repairs in a cost-effective manner.

Known techniques for detection of anomalies include use of ultrasonic or optical scanners to help a technician identify anomalies.

U.S. Pat. No. 9,217,720 provides an example of an X-ray machine that scans a peripheral area of a pipeline around the weldment and produces X-ray images corresponding to the weldment. A technician visually reviews the X-ray images to identify anomalies in the weldment. Visual inspection of the X-ray images is not consistently reliable due to human error.

U.S. Pat. No. 8,146,429 provides an Artificial Intelligence (AI) platform that uses ultrasound signals to identify location of anomalies. In this system, a neural network is provided to monitor ultrasound waveforms for presence of defect energy patterns that can help identify the location, depth, and to some extent the type of anomalies in the weldment. Due to limitations of sound waveforms, however, this system is significantly limited in the variety of types of anomalies it is capable of identifying.

US Patent Publication No. 2018/0361514 discloses an AI platform that compares cross-sectional views of a weldment against a database on training data to build truth data for the AI process to evaluable material grain structure of the weldment. The test is destructive and cannot be used for examining weldments for anomalies.

What is needed is a system to automate the anomaly and defect detection process to enable accurate and reliable detection and classification of a wide variety of types of discontinuities and anomalies in a weldment.

### SUMMARY

According to an embodiment of the invention, a non-destructive system for detecting anomalies in weldment of a pipeline is provided including an imaging apparatus, an anomaly detection unit, and a computing device. The imaging apparatus includes a sensor mountable on the pipeline and moveable around a circumferential area of the weldment, the imaging apparatus being configured to produce image segments corresponding to segments of the circumferential area of the weldment. The anomaly detection unit includes an artificial intelligence platform configured to process and analyze the image segments to identify at least one of a type, size, and location of a welding anomaly within the weldment using a database of truth data. The computing device includes a graphical user interface configured to display the image segments with an overlay of information relating to at least one of the type, size, and location of the welding anomaly to the user.

In an embodiment, the computing device displays a series of possible anomaly types associated with the welding anomaly and confidence levels for each of the possible anomaly type. In an embodiment, the series of possible anomaly types include one or more of cracks, porosity and gas pores, incomplete penetration, linear misalignment, lack of fusion, undercut root sagging, reinforcement root cavity, and blowout.

In an embodiment, the anomaly detection unit identifies a centerline of the image segments.

In an embodiment, the anomaly detection unit obtains image slices from the image segments, where the image slices collectively include a uniform centerline.

In an embodiment, the anomaly detection unit removes non-weld areas from the image slices.

In an embodiment, the anomaly detection unit segments regions of interest in the image slices.

In an embodiment, the anomaly detection unit tags pixels corresponding to the segmented regions of interest to obtain a pixel-based annotated image corresponding to each of the image slices.

In an embodiment, the truth data includes pixel-based annotated images corresponding to the truth welding anomalies.

In an embodiment, the artificial intelligence platform is configured to identify welding anomalies by comparing the pixel-based annotated images corresponding to the image slices to the pixel-based annotated images corresponding to truth welding anomalies using a neural artificial network.

In an embodiment, the artificial intelligence platform processes and analyzes the image segments to identify a depth of the location of welding anomaly within the weldment.

According to an embodiment of the invention, a process is provided for detecting anomalies in a weldment of a pipeline. The process includes the steps of: receiving image segments corresponding to segments of the circumferential area of the weldment from an imaging apparatus having a sensor mountable on the pipeline and moveable around a circumferential area of the weldment; processing the image segments using an artificial intelligence platform to identify at least one of a type, size, and location of a welding anomaly within the weldment based on a database of truth data; and displaying the image segments with an overlay information relating to at least one of the type, size, and location of the welding anomaly to the user.

In an embodiment, the method further includes displaying information related to a series of possible anomaly types associated with the welding anomaly and confidence levels for each of the possible anomaly type.

In an embodiment, the series of possible anomaly types includes one or more of cracks, porosity and gas pores, incomplete penetration, linear misalignment, lack of fusion, undercut root sagging, reinforcement root cavity, and blowout.

In an embodiment, the method further includes identifying a centerline of the plurality of image segments.

In an embodiment, the method further includes obtaining image slices from the image segments, where the image slices collectively include a uniform centerline.

In an embodiment, the method further includes segmenting regions of interest in the image slices.

In an embodiment, the method further includes tagging pixels corresponding to the segmented regions of interest to obtain a pixel-based annotated image corresponding to each of the image slices.

In an embodiment, the truth data includes pixel-based annotated images corresponding to truth welding anomalies.

In an embodiment, the method further includes identifying welding anomalies using the artificial intelligence platform by comparing the pixel-based annotated images corresponding to the image slices to the pixel-based annotated images corresponding to the truth welding anomalies using a neural artificial network.

In an embodiment, the method further includes identifying a depth of the location of welding anomaly within the weldment by analyzing and processing the image segments using the artificial intelligence platform.

### BRIEF DESCRIPTION OF THE DRAWINGS

The drawings described herein are for illustration purposes only and are not intended to limit the scope of this disclosure in any way.

FIG. 1 depicts a perspective view of an x-ray imaging device disposed for scanning a weldment connecting two pipelines, according to an embodiment;

FIG. 2 depicts an exemplary x-ray image of a completed weldment in a pipeline, according to an embodiment;

FIG. 3 depicts a block system diagram of the system of this disclosure for detecting anomalies associated with a weld, according to an embodiment;

FIG. 4 depicts an exemplary artificial neural network architecture for identifying type and location of an anomaly in a weldment, according to an exemplary embodiment;

FIG. 5 depicts an exemplary view of an image segment scanned by the imaging device, according to an embodiment;

FIG. 6 depicts a view of a linear image including the image segments arranged in series corresponding to a completed weld, according to an embodiment;

FIG. 7 depicts an exemplary flow diagram of a process executed by an anomaly detection unit to identify anomalies within the linear image, according to an embodiment;

FIG. 8 depicts a process diagram of determining and/or improving image quality of the linear image, according to an embodiment;

FIG. 9 depicts an exemplary image slice obtained by the anomaly detection unit from the linear image and after removal of private user data and identification of image slice centerline, according to an embodiment;

FIG. 10 depicts an exemplary image slice after removal of non-weldment areas and segmentation of regions of interest in the image slice, according to an embodiment;

FIG. 11 depicts an exemplary pixel-based annotated image, according to an embodiment;

FIG. 12 depicts exemplary training images corresponding to different types of anomalies used by the AI platform, according to an embodiment;

FIG. 13 depicts an exemplary graphical representation of the linear image identifying various anomalies presented to a user on a graphical user interface, according to an embodiment;

FIG. 14 depicts an exemplary graphical representation of a chart identifying confidence, coordinates, and size of an identified anomaly, according to an embodiment;

FIGS. 15-18 depict graphical representations of various linear images with identified anomalies and the associated confidences, according to an embodiment.

Corresponding reference numerals indicate corresponding parts throughout the several views of the drawings.

### DETAILED DESCRIPTION

The following description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

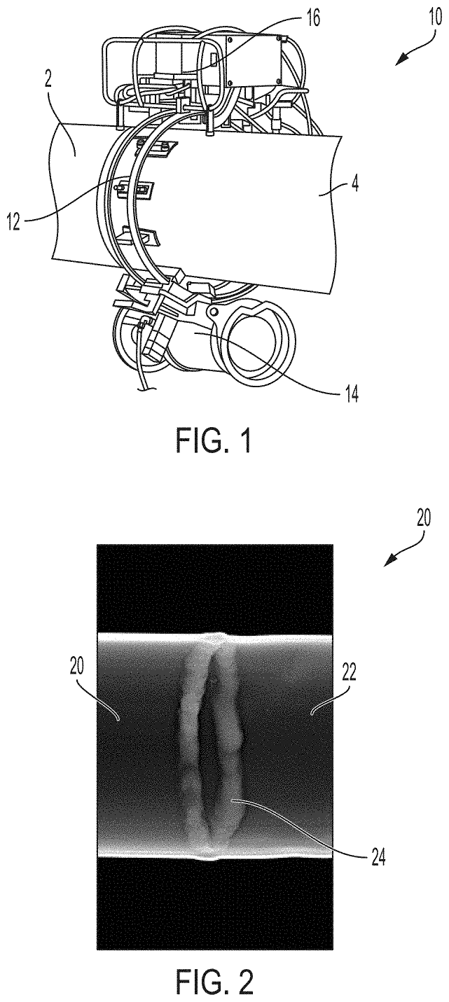

FIG. 1 depicts a perspective view of an X-ray imaging device 10 disposed for scanning a weldment connecting two pipelines 2 and 4, according to an embodiment. The imaging device 10 shown herein includes a guide rail 12 disposed around a completed weldment of a pipeline, a transmitter 14 that that transmits x-ray beams and is moveably mounted on the guide rail 12, and a receiver 16 disposed moveably on the guide rail across the transmitter 14 that receives the x-ray beams through the weldment, creating 2D images of the weldment that correspond to its current location. The transmitter 16 and receiver 18 move synchronously around the full periphery of the weldment, creating a series of images that capture the full 360 view of the weldment.

FIG. 2 depicts an exemplary image 20 representation of a completed weldment, including portions 20 and 22 corresponding to pipelines 2 and 4 and of a weld portion 24 corresponding to a completed weldment, according to an embodiment. In this example, the weldment extends 360 degrees around the connection point of the pipelines 2 and 4. In an embodiment, while image 20 is a 3D view of the weldment, the images provided by imaging devices 10 are 2D images of segments of the weldment which, when put together, represent the full circumferential length of the weldment. These images are used to help identify type, size, and location of anomalies, as described below.

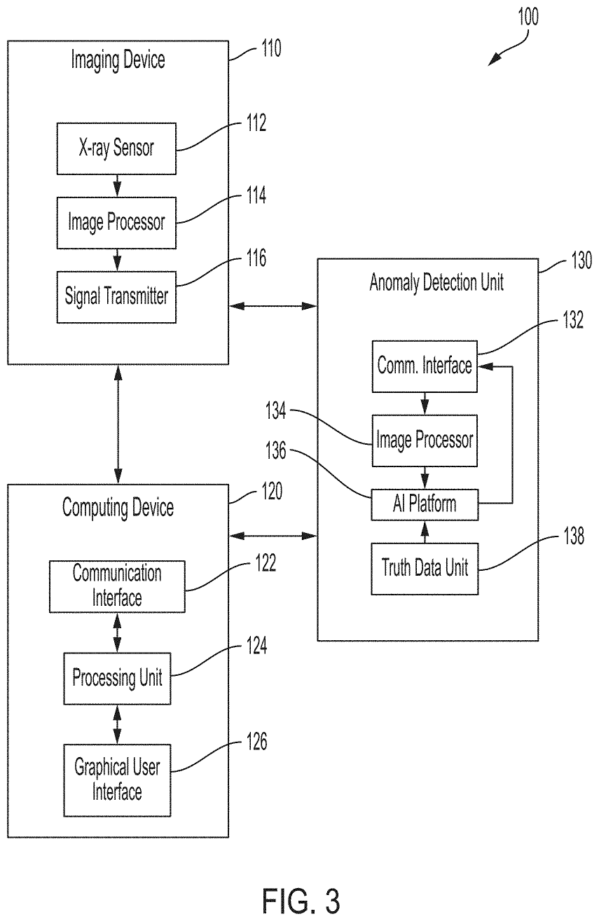

FIG. 3 depicts a block system diagram of a system 100 of this disclosure for detecting anomalies associated with weldment 20, according to an embodiment. According to an embodiment, the system 100 includes an imaging device 110 such as an X-ray imaging device 10 previously depicted in FIG. 1, an anomaly detection unit 120, and a computing device 130 operable by a user.

In an embodiment, imaging device 110 includes an imaging sensor 112, an image processor 114, and a signal transmitter 116.

In an embodiment, sensor 112 may be configured as a receiver 18 an X-ray imaging device 10 as described in FIG. 1. It should be understood, however, that other types of optical, laser, or radiation sensors capable of providing images representing the interior structure of the weld may be used alternatively.

In an embodiment, the image processor 114 processes images obtained by the sensor 112 and outputs the images in a desired format. In an embodiment, a series of discrete image segments, each corresponding to an angular segment of for example 2 to 10 percent of the weldment, may be provided by the image processor. Alternatively, image processor 114 may compile the images to provide a linear image including the image segments placed together in an array. In an embodiment, signal transmitter 116 may transmit the discrete image segments and/or the linear image array to the computing device 120 for visual review and inspection by the user. Alternatively, and/or additionally, signal transmitter 116 may transmit the discrete image segments and/or the linear image array to the anomaly detection unit 130 for autonomous inspection and detection of anomalies in the weldment.

In an embodiment, anomaly detection unit 130 may refer to a cloud-based computing platform that receives discrete image segments and/or linear image arrays from imaging device 120 and uses an autonomous artificial neural network to analyze the images for anomaly detection. In an embodiment, anomaly detection unit 130 includes a communication interface 132, an image processor 134, an AI platform 136, and a truth data unit 138. In an embodiment, communication interface 132 may be a wired or wireless communication platform configured to receive data including discrete image segments and/or linear image arrays, and send data including processed images, type and location of identified anomalies, and other statistical analyses. In an embodiment, image processor 134 may be a computing platform programed to format and process the discrete image segments and/or linear image arrays received from imaging device 110 to a desired format suitable for use by the AI platform 136. In an embodiment, the AI platform 136 uses an artificial intelligence algorithm on a neural network and truth data from the truth data unit to detect and analyze anomalies within the images.

In an embodiment, computing device 120 may be a computer or smart phone having a communication interface 122, a processing unit 124, and a graphical user interface 126. The communication interface 122 receives discrete image segments and/or linear image arrays from imaging device 110 for display on the graphical user interface 126 in a format suitable for visual inspection by the user, where the user may identify and mark areas of the images where anomalies are potentially present. The communication interface 122 may additionally and/or alternatively receive discrete image segments and/or linear image arrays from the anomaly detection unit 130 for display on the graphical user interface 126, where the user may be presented with graphical representation of the location, type, and confidence of an identified anomaly.

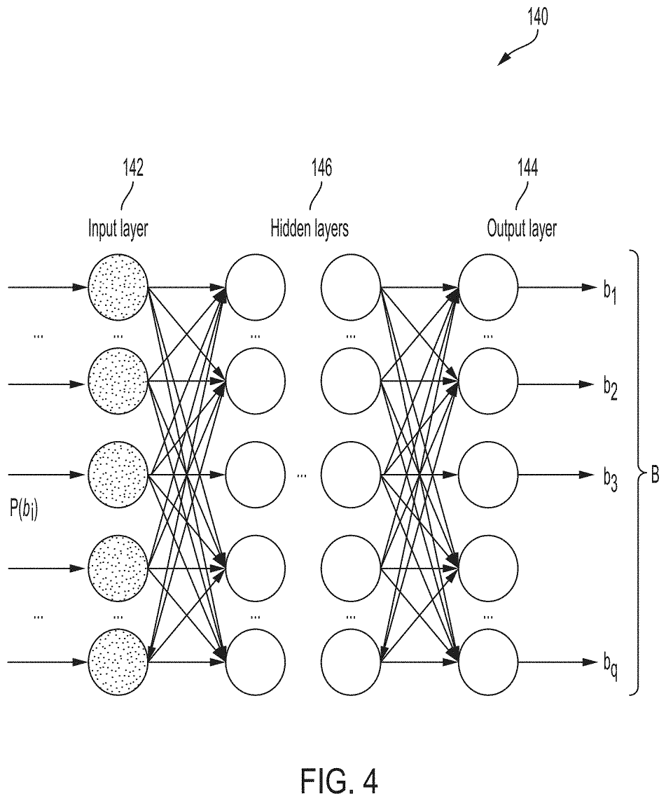

FIG. 4 depicts an exemplary artificial neural network 140 architecture for identifying type and location of an anomaly in a weld, according to an exemplary embodiment. In an embodiment, the artificial neural network 140 is a computer system capable of anomaly recognition by re-organization series of complexity filters as part of an image processing system optimized in reference to examples of particular types of anomalies in weld images. The artificial neural network includes an input layer 142 that receive inputs P(bᵢ), an output layer 144 that provide outputs B(b₁-b_{q}), and a series of hidden intermediary layers 146 in between. One or more initial neural network layers are convolutional neural network layers which each layer extract detailed and general features of the image including but not limited to orientation, edge, gamma and the latter layers of this network consolidates and combines various structures to determine the likelihood of each type of anomaly.

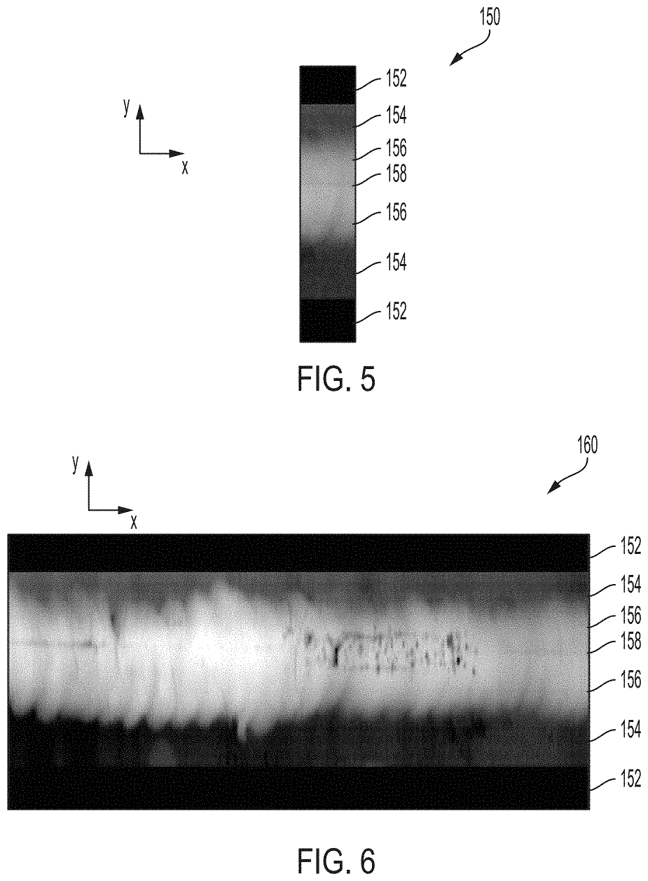

FIG. 5 depicts an exemplary view of an image segment 150 scanned by the imaging device, according to an embodiment. In an embodiment, the image segment 150 corresponds to an area of approximately 2 to 10 percent of the total weldment, or an angular area of approximately 5 to 30 degrees of the total 360 degrees of the total weldment. In an embodiment, the x-axis of the image segment 150 is parallel to the peripheral axis of the weld, and the y-axis corresponds to the thickness of the weld. In an embodiment, the image segment 150 includes non-weld upper and lower areas 152, HAZ upper and lower areas 154, TMAZ upper and lower areas 156, and a central weld nugget area 158.

FIG. 6 depicts a view of a linear image 160 including the image segments 150 arranged in series corresponding to a completed weld, according to an embodiment. In an embodiment, the image segments are aligned together longitudinally (i.e., along the x-axis). In an embodiment, the linear image 160 may represent a 360 view of the weld around the pipeline.

In an embodiment, imaging device may transmit the linear image to the anomaly detection unit 130 once the full image of the weld has been obtained. Alternatively, imaging device may transmit the image segments individually as they are captured by the x-ray sensor to allow dynamic and faster processing of images and identification of anomalies by the anomaly detection unit 130.

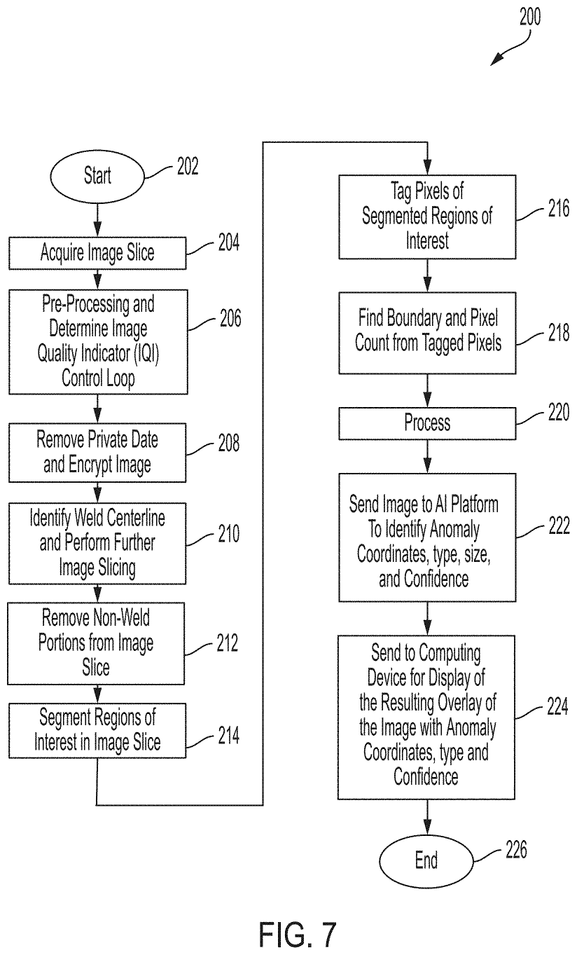

FIG. 7 depicts an exemplary flow diagram of a process 200 executed by the anomaly detection unit 130 to identify anomalies within the linear image 160, according to an embodiment. In an embodiment, after the start 202 of the process, a series of image slices are acquired from the linear image at step 204. In an embodiment, image slices may correspond to the original image segments, through alternatively image slices may be different widths than the original image segments. Next, image slices are processed to determine an image quality indicator (101) of the image and make enhancements to the image where appropriate at step 204. If the quality factors of image need further pre-processing enhancement will occur inside a feedback look until quality of image meets certain pre-determined thresholds. It is noted that this step may be performed by the anomaly detection unit 130, the imaging device 110, or the computing device 120, independently or in cooperation. Next, any private data that associated the image slices with consumer information is removed from the image slice or portions of the image are encrypted at step 208. Next, a centerline of the image slice is determined, and further image slicing is performed where needed, at step 210. The centerline refers to the center of the weld nugget portion of the weld. Where the slice does not include a uniform centerline, it is further divided to sub-slices, each with its own centerline. Next, the excessive non-weld portions are removed from the image slice at step 212. As described above, non-weld portions of the image slices refer to upper and lower areas of the images that are outside the HAZ portions 154. Next, the image slice is segmented to identify its regions of interest (i.e., HAZ, TMAZ, and nugget) at step 214. Next, a pixel-based annotated image is produced at step 216 by tagging pixels distinguishing the segmented regions of interest and areas of anomaly. Next, pixel boundary and pixel count are identified from the pixel-based annotated image at step 218 and the image is processed at step 220. Next, the image is sent to the AI platform 136 to identify anomaly coordinates, type, size, and confidence at step 222. The AI platform 136 uses the neural network and the truth data including images of weld anomalies to identify the anomaly type, measure its size, and calculate the confidence level of the anomaly being correctly identified. This data is then sent to the computing device 120 or the cloud for display of the resulting overlay of the image with identification of anomaly location, anomaly type, and anomaly confidence at step 224. The process ends at step 226.

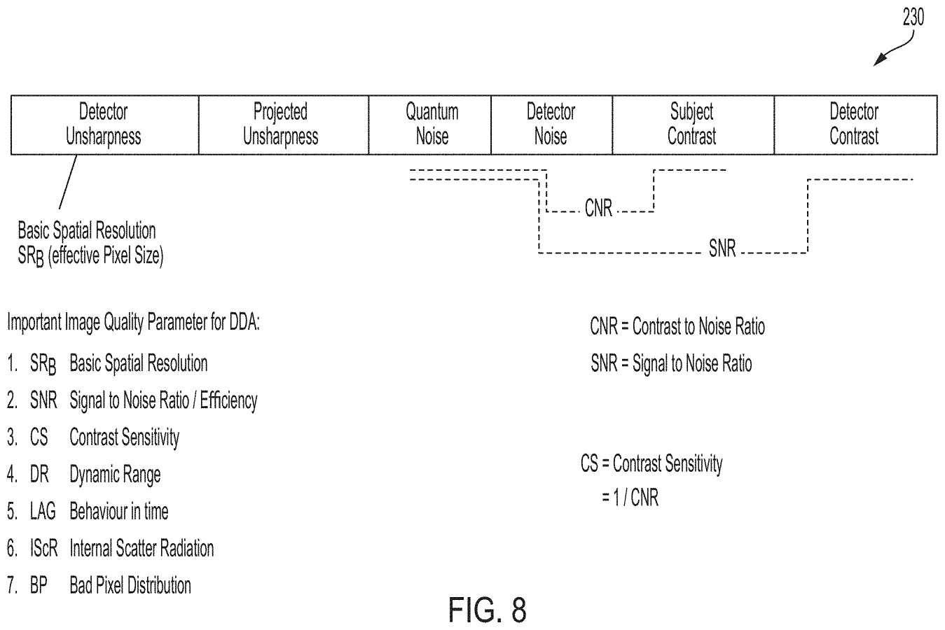

FIG. 8 depicts a process diagram 230 of determining and/or improving image quality of the linear image 160, according to an embodiment. This process 230 may be performed in step 206 of process 200 described above. In this process, the image sharpness, signal to noise ratio, contrast sensitivity, pixel distribution and intensity, etc. are identified and adjusted to improve the image quality. As noted above, this step may be performed by the anomaly detection unit 130, the imaging device 110, or the computing device 120, independently or in cooperation. Execution of this process 230 may be performed automatically or by receiving inputs from the user.

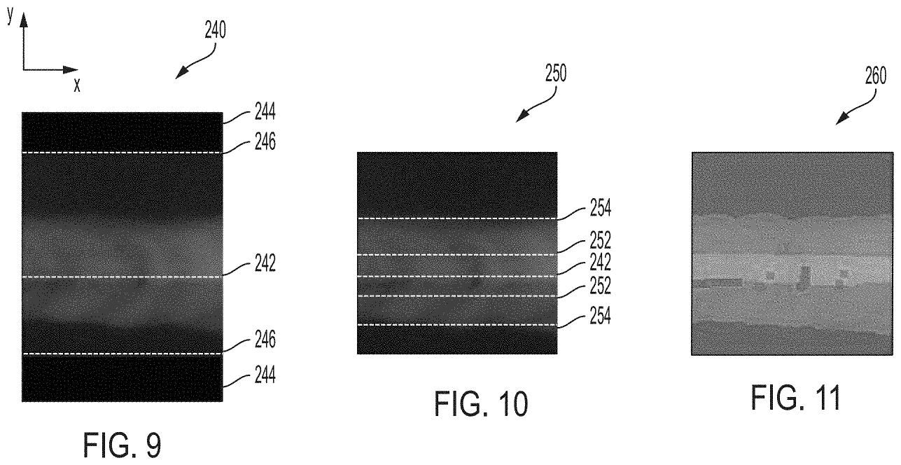

FIG. 9 depicts an exemplary image slice 240 obtained by the anomaly detection unit 130 from the linear image 160 and after removal of private user data and identification of image slice centerline 242, according to an embodiment. While the weld is oriented longitudinally in the x-ray image, it may deviate from the longitudinal axis sinusoidally in the transverse direction due to slight misalignment between the weld and the x-ray sensor. Thus, selecting a simple global region of interest around the approximate weld centerline 242 will not optimally center the weld within the region of interest for the purpose of passing to later processing steps. In an embodiment, identifying the centerline 242 of each image slice 240 rather than the linear image 160 as a whole allows the anomaly detection unit 130 to optimally account for such traversal deviations. In an embodiment, the centerline 242 is identified by first obtaining a global estimate of the transverse location of the weld centerline, and then to locally refining this estimate within each image slice 240 or sub-section of the image slice 240. In an embodiment, this is done by selecting a patch of the image slice 240, multiplying the selected patch of the input image slice by a Gaussian window centered at the global estimate, and performing a flood-fill above a certain threshold originating from the maximum of the Gaussian-windowed image. The local patch is then used to roughly equalize the below-threshold background areas 244 (i.e., dark space areas) that appears above and below the weld boundary 246, thus ensuring that the weld is optimally framed within each patch despite local intensity variations within the weld.

FIG. 10 depicts an exemplary processed image slice 250 after removal of excessive non-weldment background areas 244 and segmentation of regions of interest 252 and 24 in the image slice, according to an embodiment.

FIG. 11 depicts an exemplary pixel-based annotated image 260 obtained from the processed image slice 250, according to an embodiment.

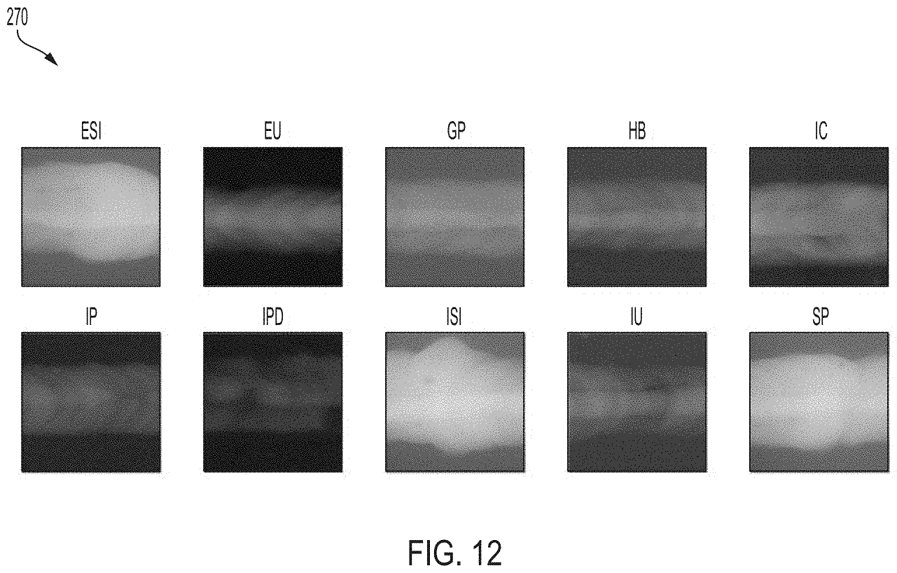

FIG. 12 depicts exemplary training images 270 corresponding to different types of anomalies used by the AI platform, according to an embodiment. In an embodiment, different anomalies include different shapes, sizes, and locations relative to the regions of interest. Examples of these anomalies include, but are not limited to, Elongated Slag Inclusion (ESI), Eternal Undercut (EU), Cluster Porosity (CP), Hollow-Head Porosity (HB), Internal Concavity (IC), Inadequate Penetration without High-Low (IP), Inadequate Penetration with High-Low (IPD), Isolated Slug Inclusion (ISI), Internal Undercut (IU), and Scattered Porosity (SP). While these images are provided by way of example, in an embodiment, the training images may be focused on the anomaly with pixel-based tagging and/or polygon bounding boxes.

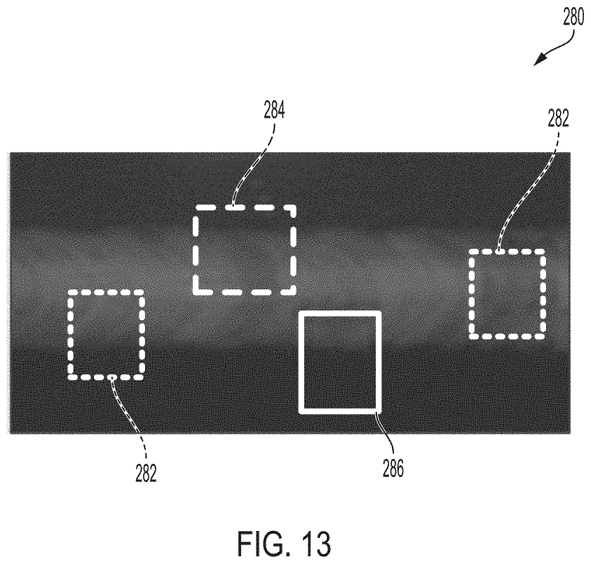

FIG. 13 depicts an exemplary graphical representation 280 of a linear image 160 identifying various anomalies presented to a user on a graphical user interface, according to an embodiment. In an embodiment, the graphical user interface may present one or more color-coded boundaries (in this example provided with different boundary patterns) 282-286 around an identified anomaly and allow the user to interactively select an anomaly for display of additional information. Different color codes around or associated with the rectangular bounding areas 282-286 can be used to classify perceived anomalies or potential areas of interest. For example, area 282 (shown in dotted lines, but may be presented to the user in red) may show anomalies, while area 284 (shown in dashed line, but may be presented in green) may be used to identify normal characteristics that might be mistaken by anomalies, and area 286 (shown in solid line, but may be presented in white) may indicate detected anomalies with lower significance or an interval of a lower confidence or significance.

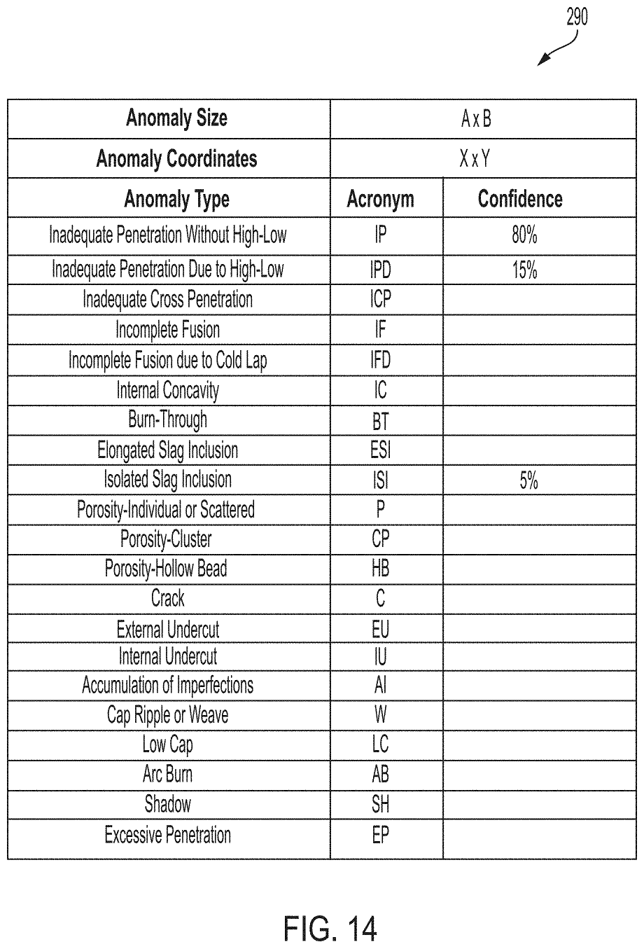

FIG. 14 depicts an exemplary graphical representation of a chart 290 identifying confidence, coordinates, and size of an identified anomaly, according to an embodiment. In an embodiment, upon receiving the user selection of an anomaly through the graphical representation 280 of FIG. 13, e.g., when the user clicks on one of the areas 282-286, the chart 290 is presented to the user depicting data identifying the size and coordinates of the anomaly within the image, as well as the type of anomaly identified by the anomaly detection unit 130. In an embodiment, where the anomaly detection unit 130 identifies several possible types of anomaly, it presents confidence level (i.e., calculated probability) that the detect is correctly identified. In the illustrated example, the anomaly in area 282 of FIG. 13 is identified as being inadequate penetration without high-low with an 80% confidence level, or an inadequate penetration due to high-low with a 15% confidence lever. There is also a 5% possibility that the anomaly is an isolated slag inclusion.

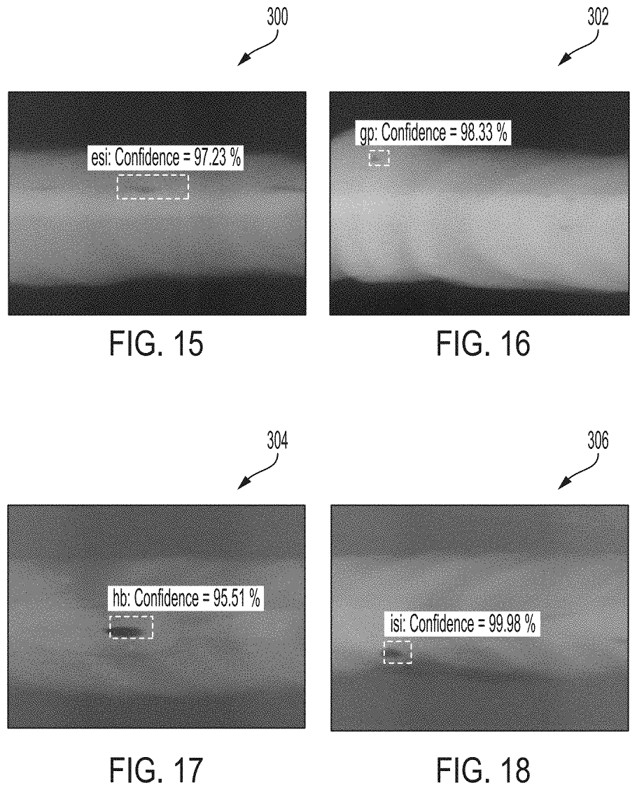

FIGS. 15-18 depict graphical representations of various exemplary linear images 300-306 with identified anomalies and the associated confidences, according to an embodiment. In this example, FIG. 15 depicts an identified ESI anomaly with a 97.23% confidence, FIG. 16 depicts an identified GP anomaly with a 98.33% confidence, FIG. 17 depicts an identified HB anomaly with a 95.51% confidence, and FIG. 18 depicts an identified ISI anomaly with a 99.98% confidence.

Some of the techniques described herein may be implemented by one or more computer programs executed by one or more processors residing, for example on a power tool or photon digital detector. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

1. A non-destructive system for detecting anomalies in a weldment of a pipeline comprising:
an imaging apparatus having a sensor mountable on the pipeline and moveable around a circumferential area of the weldment, the imaging apparatus being configured to produce a plurality of image segments corresponding to a plurality of segments of the circumferential area of the weldment;
an anomaly detection unit comprising an artificial intelligence platform configured to process and analyze the plurality of image segments to identify at least one of a type, size, and location of a welding anomaly within the weldment based on a database of truth data; and
a computing device having a graphical user interface configured to display the plurality of image segments with an overlay of information relating to at least one of the type, size, and location of the welding anomaly to the user.

2. The system of claim 1, wherein the computing device is further configured to display a series of possible anomaly types associated with the welding anomaly and confidence levels for each of the possible anomaly type.

3. The system of claim 1, wherein the series of possible anomaly types comprises one or more of cracks, porosity and gas pores, incomplete penetration, linear misalignment, lack of fusion, undercut root sagging, reinforcement root cavity, and blowout.

4. The system of claim 1, wherein the anomaly detection unit is configured to identify a centerline of the plurality of image segments.

5. The system of claim 4, wherein the anomaly detection unit is further configured obtain a plurality of image slices from the plurality of image segments, wherein the plurality of image slices collectively includes a uniform centerline.

6. The system of claim 1, wherein the anomaly detection unit is configured to remove non-weld areas from the plurality of image slices.

7. The system of claim 1, wherein the anomaly detection unit is configured to segment regions of interest in the plurality of image slices.

8. The system of claim 7, wherein the anomaly detection unit is configured to tag pixels corresponding to the segmented regions of interest to obtain a pixel-based annotated image corresponding to each of the plurality of image slices.

9. The system of claim 8, wherein the truth data comprises a plurality of pixel-based annotated images corresponding to a plurality of truth welding anomalies.

10. The system of claim 9, wherein the AI platform is configured to identify welding anomalies by comparing the pixel-based annotated images corresponding to the plurality of image slices to the pixel-based annotated images corresponding to the plurality of truth welding anomalies using a neural artificial network.

11. The system of claim 1, wherein the artificial intelligence platform is configured to process and analyze the plurality of image segments to identify a depth of the location of welding anomaly within the weldment.

12. A method of detecting anomalies in a weldment of a pipeline comprising:
receiving a plurality of image segments corresponding to a plurality of segments of the circumferential area of the weldment from an imaging apparatus having a sensor mountable on the pipeline and moveable around a circumferential area of the weldment;
processing the plurality of image segments using an artificial intelligence platform to identify at least one of a type, size, and location of a welding anomaly within the weldment based on a database of truth data; and
displaying the plurality of image segments with an overlay information relating to at least one of the type, size, and location of the welding anomaly to the user.

13. The method of claim 12, further comprising displaying information related to a series of possible anomaly types associated with the welding anomaly and confidence levels for each of the possible anomaly type.

14. The method of claim 13, wherein the series of possible anomaly types comprises one or more of cracks, porosity and gas pores, incomplete penetration, linear misalignment, lack of fusion, undercut root sagging, reinforcement root cavity, and blowout.

15. The method of claim 12, further comprising identifying a centerline of the plurality of image segments.

16. The method of claim 15, further comprising obtaining a plurality of image slices from the plurality of image segments, wherein the plurality of image slices collectively includes a uniform centerline.

17. The method of claim 12, further comprising segmenting regions of interest in the plurality of image slices.

18. The method of claim 17, further comprising tagging pixels corresponding to the segmented regions of interest to obtain a pixel-based annotated image corresponding to each of the plurality of image slices.

19. The method of claim 18, wherein the truth data comprises a plurality of pixel-based annotated images corresponding to a plurality of truth welding anomalies.

20. The method of claim 19, further comprising identifying welding anomalies using the artificial intelligence platform by comparing the pixel-based annotated images corresponding to the plurality of image slices to the pixel-based annotated images corresponding to the plurality of truth welding anomalies using a neural artificial network.

21. The method of claim 12, further comprising identifying a depth of the location of welding anomaly within the weldment by analyzing and processing the plurality of image segments using the artificial intelligence platform.
